(19) United States
(12) Patent Application Publication
(10) Pub. No.: US 2002/0184257 A1
(43) Pub. Date: Dec. 5, 2002

(54) Method of transferring a certain version of an object description

(76) Inventor: Sylvain Devillers, Paris (FR)

Correspondence Address: PHILIPS ELECTRONICS NORTH AMERICAN CORP, 580 WHITE PLAINS RD, TARRYTOWN, NY, 10591, US

(21) Appl. No.: 10/100,598

(22) Filed: Mar. 18, 2002

(30) Foreign Application Priority Data
Mar. 20, 2001 (FR) 0103778

(51) Int. Cl. G06F 15/00

(52) U.S. Cl. 707/500; 707/521

(57) ABSTRACT

The invention proposes a system for transferring an object from a source entity to a destination entity, in which:

the source entity includes:

means for storing at least a progressive file organized in several parts and containing a maximum version of an object,

means for storing at least an electronic document describing a page intended for display on a screen, said document having an access point (an inclusion or a link) which specifies said progressive file, said access point specifying at least one or more parts of said progressive file corresponding to at least one version of said object,

and means for transmitting the electronic document to the destination entity, and the whole progressive file or part thereof,

and the destination entity includes:

means for receiving and interpreting the electronic document,

and means for transmitting a request to said source entity, wherein said request specifies one or more parts of the progressive file, obtained from reading of the access point for the purpose of transferring said part or parts of the progressive file from said source entity to said destination entity.

### FIELD OF THE INVENTION

The present invention relates to a method of transferring an object from a source entity to a destination entity, including a step of transmitting a request from the destination entity to said source entity, wherein said request specifies one or more parts of a progressive file containing a maximum version of said object, and a step of transferring the part or parts of said progressive file from the source entity to the destination entity.

The invention also relates to a computer program including instructions for the implementation of such a transfer method.

The invention further relates to a transmission system including a source entity and a destination entity capable of implementing such a method. It also relates to such a source entity, for example a server, and such a destination entity, for example consumer electronic device.

The invention also relates to an electronic document describing at least a page intended for display on a screen of an electronic equipment, said document having at least an access point that specifies a progressive file organized in several parts and containing a maximum version of an object.

The invention has important applications specifically in the Internet domain. More and more consumer electronic devices have access to the Internet network. This is the case for example with personal computers, mobile telephones, digital personal assistants, portable computers, pocket computers. These platforms have more or less limited hardware and software resources (screen, calculation capacity, storage capacity . . . ), and are connected to the Internet by links having various rates (wire, radio, optical links . . . ). The objects to be transferred need to be adapted to match the destination profile. By matching the destination profile, transmission of data which cannot be used by the addressee is avoided. Thus passband is saved.

### BACKGROUND OF THE INVENTION

International patent application WO 99/41734 describes a transfer method of a certain version of an object from a source entity (for example an Internet server) to a destination entity (for example, a personal computer connected to the Internet).

The method described in this international patent application consists of storing at the Internet server side a progressive file organized in several sections and containing a graphics object, and of providing the client with an adapted browser plug-in. This browser plug-in is used by the client to determine the sections he requires in the progressive file, and to transmit to said server a request that specifies said sections, for the purpose of getting a version of said object adapted to its profile or its requirements.

The browser plug-in used by the client is specific and smart: it knows the coding format of the progressive file and knows which sections it must retrieve to have such and such resolution or quality of the graphics object.

According to this prior art, every client must have one browser plug-in available for each progressive file format likely to be transferred. This is complex and expensive.

### SUMMARY OF THE INVENTION

It is notably an object of the invention to propose a transfer method that does not present this disadvantage. A method according to the invention of transferring an object from a source entity to a destination entity includes:

a step of transmitting an electronic document from the source entity to the destination entity which document describes at least a page intended for display on a screen, and having at least an access point that specifies a progressive file organized in several parts and containing a maximum version of said object, wherein said access point specifies at least one or more parts of said progressive file corresponding to at least one version of said object,

a step of interpreting said document by the destination entity,

a step of transmitting a request from said destination entity to said source entity, wherein said request specifies one or more parts of said progressive file, obtained from reading said access point,

and a step of transferring said part or parts of said progressive file, from said source entity to said destination entity.

An access point according to the invention is constituted for example by an inclusion of an object, or by a link to a file that contains a certain version of an object.

The invention applies to objects coded by using a progressive coding format. According to the invention, a version called maximum object version is contained in a progressive file stored at the source entity. When a page offers access to such an object, the source entity makes an indication in the electronic document which describes this page and which is to be transmitted to the destination entity, one or more possible version(s) for said object, together with the corresponding parts of the progressive file. The destination entity itself therefore does not have to determine the parts to be transferred: it reads them directly from the received electronic document. Therefore, no browser plug-in is necessary.

In addition, the invention permits a server to offer different versions of the same object, for example on different pages of the same Internet site, without the need to store a file for every version. In this regard the invention thus permits to minimize the amount of data to be stored on the server.

In an advantageous embodiment of the invention the electronic document transmitted by the server is an HTML document. An object inclusion is constituted by an OBJECT element that includes one or more PARAM sub-elements, each corresponding to a version of said object. Every PARAM sub-element includes a VALUE attribute which contains the parts of the progressive file which correspond to said version. A link is fragment identifier which contains the part or parts of the file that are to be transferred. Said destination entity sends an HTTP request to the source entity, said HTTP request relating to a GET method that includes a RANGE header, said RANGE head indicating the part or parts of said progressive file that are specified in the link or the inclusion.

A further object of the invention is to propose an electronic document as described in the introduction and characterized in that said access point specifies at least one or more parts of said progressive file corresponding to at least one version of said object.

It is also an object of the invention to propose a server that includes storage means for at least a progressive file organized in several parts and containing a maximum version of an object, and storage means for at least an electronic document that describes at least a page intended for display on a screen of electronic equipment, said document including at least an access point that specifies said progressive file, and said access point specifying at least one or more parts of said progressive file that correspond to at least one version of said object.

Another object of the invention is to propose electronic equipment that includes a screen, means for reception and interpretation of an electronic document which describes at least a page intended for display on said screen, said document including at least an access point that specifies a progressive file organized in several parts, containing a maximum version of an object, and stored in a source entity, said access point specifying at least one or more parts of said progressive file corresponding to at least one version of said object, and means for transmission of a request to said source entity, wherein said request specifies one or more parts of the progressive file, obtained from reading said access point, so as to transfer said part or parts of said progressive file from the source entity to the destination entity.

### BRIEF DESCRIPTION OF THE FIGURES

These and other aspects of the invention are apparent from and will be elucidated, by way of non-limitative example, with reference to the embodiment(s) described hereinafter.

In the drawings:

FIG. 1 is a diagram representing an example of a transmission system according to the invention,

FIG. 2 is a flow chart describing the operations which are performed for implementation of a transfer method according to the invention.

### DESCRIPTION OF A PREFERRED EMBODIMENT OF THE INVENTION

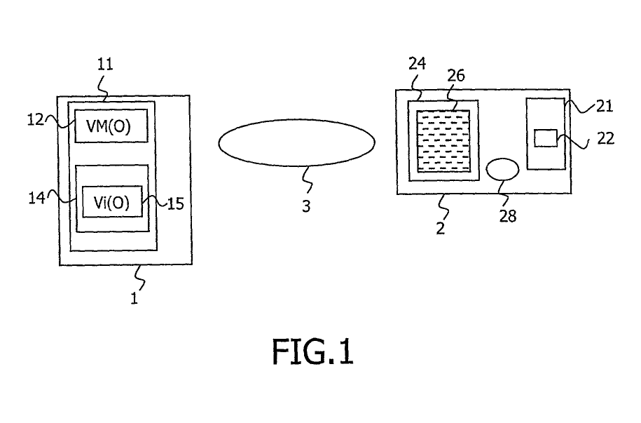

In FIG. 1 an example is illustrated of the transmission system according to the invention including a source entity 1, a destination entity 2 and a transmission network 3. The source entity includes a memory 11 which contains a file 12. The file 12 is a progressive file that contains a maximum version VM(O) of an object O.

A progressive file is a file organized in several parts, a first part giving a first version of the object, and the addition of each following part then permits to obtain ever more complete versions of the same object.

By way of example the image encoding format JPEG 2000 (ISO/IEC FCD15444-1 standard) is a progressive format. The JPEG 2000 standard provides for the use of four elementary schemes of progressivity: by resolution, by quality, by spatial location and by component. JPEG 2000 also proposes five combinations of these elementary schemes. Every scheme of progressivity corresponds to a specific method of ordering the data in the JPEG 2000 bitstream. For example, if an object has been coded with a progressivity by resolution, the first bytes of the progressive file give a low resolution of the object, and the following bytes progressively permit greater resolution of the object.

The memory 11 also contains an electronic document 14. The electronic document 14 describes a page intended for display on a screen. It contains an access point 15 which specifies the progressive file 12. This access point for example is an inclusion of a version Vi(O) of the object O, or a link to one or more parts of the progressive file 12 that correspond to a version Vi(O) of the object O.

The destination entity 2 includes a memory 21 which stores a program 22 called user agent (in general, a user agent is a program that interprets HTML type documents; a browser is an example of a user agent). The destination entity 2 also includes a display screen 24 which specifically permits the display of a page 26 described in an electronic document received via the transmission network 3. It also includes link activation means 28 that may be offered on such a page. These link activation means 28 are constituted for example by a mouse, by keyboard keys, or by voice control. The user agent 22 mainly has the task of interpreting electronic documents received via the transmission network 3, which describe one or more pages intended for display on the screen 24. In particular, when it finds an element describing an object inclusion, it issues a request to cause the transfer of said object. The user agent 22 also has the task of issuing a request every time a link is activated by a user, to transfer the file or the file part identified by said link.

In a general manner, an object inclusion specifies the location of the data that constitute the object. This location has the form of a resource identifier. According to the invention, when the file is a progressive file containing a maximum version of an object, the inclusion specifies, in addition, at least one or more parts of the file that correspond to a version of the object. In certain cases it specifies several sets of one or more file parts corresponding to different object versions. The user agent 22 reads the version or versions offered. If several versions are offered, it selects the one that is best suited to its requirements. Then, it issues a request to the source entity 1 to cause the transfer of said version. This request specifies the file part or parts corresponding to the version to be transmitted, in addition to the resource identifier associated with said file.

The electronic documents that describe pages for display are for example HTML4 documents (HTML4 is a content description language defined by the W3C “consortium). In this case “OBJECT” elements are used advantageously to make inclusions “relating to a file. The “DATA” attribute is used to identify the file. It contains a resource identifier relating to that file. The “TYPE” attribute is used to specify the type of file. According to the invention, when the file in question is a progressive file that contains a maximum version of an object, one or more “PARAM” sub-elements are contained in the “OBJECT” element. Each “PARAM” sub-element is used to specify one or more parts of the progressive file corresponding to an object version. A “PARAM” sub-element contains an attribute “NAME” which indicates the name of the sub-element, and an attribute “VALUE” which indicates the part or parts of the file. The PARAM sub-elements that are used to specify one or more parts of the progressive file corresponding to an object version all have the same name. In examples that will be given hereunder the name “retrieveParameters” is used. When several versions are offered, the “VALUE” attribute also contains a version identifier allowing the user agent 22 to find the offered versions and make its selection. In the examples that will be given hereunder two version identifiers are used, “Resolution 640×480” and “Resolution 800×600”. The meaning of version identifiers must be known to the source entity and the destination entity. In this example, the user agent 22 chooses version 640×480 or version 800×600 according to the size of the screen 24.

Another way of specifying one or more parts of a file is to complete the resource identifier contained in the “DATA” attribute with a fragment identifier. To achieve this while remaining compliant with recommendation RFC2396 of the IETF which describes uniform resource identifiers, a syntax is used for example of the type “myImage.jp2#0-29_{—}40-59_{—}60-99” to inform that the inclusion relates to the ranges of bytes 0 to 29, 40 to 59 and 60 to 99 of a file “myImage.jp2”. In this example the resource identifier is constituted by “myImage.jp2”, and the fragment identifier by “0-29_{—}40-59_{—}60-99”. According to the provisions of RFC 2396, the resource identifier is separated from the fragment identifier by the “#” sign. The sign “_” is used to separate the various byte ranges because RFC2396 does not permit the use of spaces.

Recommendation HTML4.01 uses “A” elements to place links in an electronic document. An element “A” contains an “href” attribute that specifies a resource identifier possibly followed by a fragment identifier. According to the invention, a syntax of type <A href: “myImage.jp2#0-29_{—}40-59_{—}60-99”></A> is used to specify one or more parts of a link file.

The request emitted by the destination entity 2 is for example an HTTP request (HTTP is the HyperText Transfer protocol defined in RFC2616 and currently used on the Internet). For example, this request relates to a “GET” method, and it includes a “RANGE” header in which are indicated said part or parts of the progressive file that are to be transferred. For more detail reference is made to the RFC 2616, which describes HTTP/version 1.1. In general manner, an HTTP request message contains an identifier of the method used (here GET), a resource identifier to identify resources to which the request pertains, and an identifier of the HTTP version used. According to the invention a RANGE header as described in paragraph 14.35 of RFC 2616 is also used to indicate the parts of the file involved in the request.

We will now provide two examples of applications of the invention. In a first example of application of the invention one image is included in one page, but the user agent 22 has the choice of the version to be displayed. In this case the HTML code of the Web page contains an “OBJECT” element of type:

```
<OBJECT data = ,,myImage.jp2″ type = ,,image/jpeg2000″>
<!-- first version: resolution 640x480-->
  <PARAM name = ,, retrieveParameters″
  value = ″resolution: 640x480 Range: 0-29, 40-59″>
</PARAM>
<!--second version: resolution 800x600-->
<PARAM name =“retrieveParameters″
  value = ″resolution: 800x600 Range: 0-29, 40, 59, 60-99 ″>
</PARAM>
</OBJECT>
```

For this same application the following syntax can also be used, in which different objects are nested, and each can be characterized by a PARAM element giving the ranges of the file to be transferred. According to the HTML4.01 syntax explained in chapter 13.3.1 of the standard, the user agent 22 tries to retrieve the first object in the hierarchy, possibly characterized by a PARAM element. If it cannot retrieve this, it tries to retrieve the object included in this first object, itself possibly characterized by a PARAM element, and so forth, the nesting of the objects giving a sequence of versions of the same object, of which only one version is to be retrieved by the user agent 22.

<OBJECT data = ″myImage.jp2 ″ type = ″image/jpeg2000 ″>
<!--first version: resolution 800x600-->
<PARAM name = ,,retrieveParameters″
value = ″ resolution: 800x600 Range: 0-29, 40-59, 60-99″>
</PARAM>
<!--Else, second version: resolution 640x480-->
<OBJECT data = ″myImage.jp2 ″ type = ″image/jpeg2000 ″>
<PARAM name = ,,retrieveParameters″
value = ″resolution: 640x480 Range: 0-29, 40-59, 60-99″>
</PARAM>
</OBJECT>
</OBJECT>

In a second example of application of the invention, a Web site offers an image in thumbnail format on its home page to avoid having to download large quantities of data, and permits the user to download a larger picture by clicking on the thumbnail picture. In this case the HTML code of the home page is of the type:

<A href: ,, myImage.jp2#0-29_40-59_60-99″>
<OBJECT data = ,, myImage.jp2 ″ type = ″ image/jpeg2000″>
<PARAM name = ,, retrieveParameters ″ value = ″ Range:
0-29, 40-59 ″>
</PARAM>
</OBJECT>
</A>

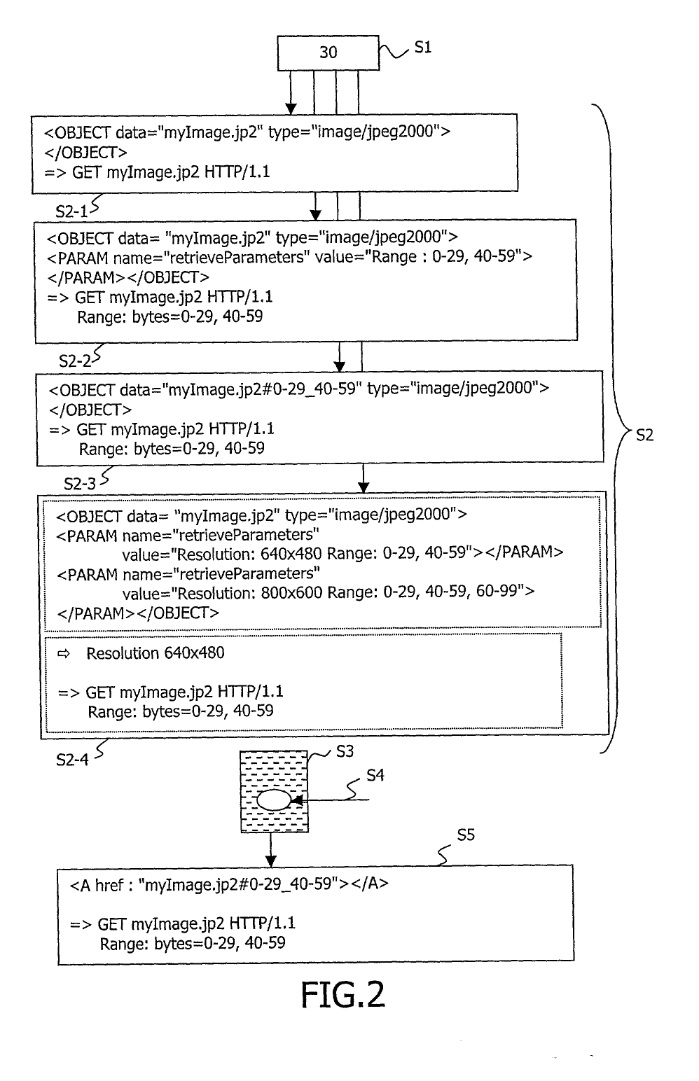

In FIG. 2 a flow chart is represented describing operations that are preformed to implement a transfer method according to the invention.

In step S1, a destination entity 2 receives an electronic document 30 that describes a page 32.

In step S2 the user agent 22 of the destination entity 2 interprets this electronic document 30 to display the page 32 on screen 24. For this purpose the browser scrolls through the electronic document 30.

When it finds an OBJECT element that does not contain a PARAM sub-element (case S2-1), it issues an HTTP request for the whole of the file concerned.

When it encounters an OBJECT element that contains a unique PARAM sub-element entitled “retrieveParameter”, which indicates one or more parts of file to be retrieved (case S2-2), it issues an HTTP request that includes a RANGE header and the content of which is constituted by the value of sub-element PARAM, that is to say, by the parts of the file to be retrieved.

Similarly, when it encounters an OBJECT element whose “DATA” attribute contains a fragment identifier (box S2-3), it issues an HTTP request that includes a RANGE header specifying the range or ranges of bytes indicated by the fragment identifier.

Finally, when it encounters an OBJECT element that contains several PARAM sub-elements entitled “retrieveParameter” each corresponding to a different version of the same object, or when it encounters an OBJECT element that contains one or several OBJECT sub-elements possibly characterized by a PARAM element, each corresponding to a different version of the same object (case S2-4), it selects from among the proposed versions the one that is suited to its needs. Identifiers of different versions, as well as the corresponding parts of the file, are indicated in the “VALUE” attribute of the PARAM sub-elements. Then it issues an HTTP request that includes a RANGE header the contents of which are formed by the file parts indicated in the “VALUE” attribute of the selected sub-element. For example, if the browser chooses the version identified by “resolution 640×480”, the RANGE header contains the expression “Range: 0-29, 40-59”.

In step S3, the user agent 22 displays the page 32 on the screen 24.

In step S4 the user activates a link proposed on page 32. The user agent 22 then issues an HTTP request that retrieves the resource identifier specified in the link and, when the link further specifies a fragment identifier, that in addition includes a RANGE header whose contents consist of the range or ranges of bytes indicated by the fragment identifier.

The invention is not limited to the use of HTML4. It is applicable to other languages of the same type, for example to XHTML, or languages defined in the WAP or I-MODE environments used for Internet applications on a mobile phone. Similarly, the invention is not limited to the use of the HTTP network protocol. It is applicable to any reliable network protocol that permits specifying a range of bytes to be retrieved. For example, it is applicable to the protocols used in the WAP or I-MODE environment. Finally, the invention is not limited to the use of the JPEG 2000 coding standard. It is applicable to any progressive file type, for example to an MPEG-4 video file.

1. An electronic document describing at least a page intended for display on a screen of electronic equipment, the document including at least an access point that specifies a progressive file organized in several parts and containing a maximum version of an object, characterized in that said access point specifies at least one or more parts of the progressive file corresponding to at least one version of said object.

2. An electronic document as claimed in claim 1, characterized in that the access point is an inclusion.

3. An electronic document as claimed in claim 1, characterized in that the access point is a link to said progressive file.

4. A method of transferring an object from a source entity to a destination entity including:
a step of transmitting an electronic document from the source entity to the destination entity which document describes at least a page intended for display on a screen, and having at least an access point that specifies a progressive file organized in several parts and containing a maximum version of said object wherein said access point specifies at least one or more parts of said progressive file corresponding to at least one version of said object,
a step of interpreting said document by the destination entity,
a step of transmitting a request from said destination entity to said source entity, wherein said request specifies one or more parts of said progressive file, obtained from reading said access point,
and a step of transferring said part or parts of said progressive file from said source entity to said destination entity.

5. A computer program product including instructions for implementing a transfer method as claimed in claim 4.

6. A server including storage means:
of at least a progressive file organized in several parts and containing a maximum version of an object,
and of at least an electronic document describing at least a page intended for display on a screen of electronic equipment, said document including at least an access point that specifies said progressive file, characterized in that said access point specifies at least one or more parts of the progressive file corresponding to at least one version of the object.

7. Electronic equipment including:
a screen,
means for receiving and interpreting an electronic document which describes at least a page intended for display on said screen, said document having at least an access point that specifies a progressive file organized in several parts, containing a maximum version of an object, and stored in a source entity, and said access point specifying at least one or more parts of said progressive file corresponding to at least one version of said object,
and means for transmitting a request to said source entity, wherein said request specifies one or more parts of said progressive file, obtained from reading the access point in view of the transfer of the part or parts from the source entity to said destination entity.

8. Electronic equipment as claimed in claim 8, characterized in that said request is an HTTP request that relates to a GET method which pertains to the progressive file, said request including a RANGE header in which are indicated said part or parts of the progressive file which are to be transferred.

9. A transmission system including at least a source entity and a destination entity,
said source entity including storage means for at least a progressive file organized in several parts and containing a maximum version of an object, and at least an electronic document describing at least a page intended for display on a screen, said document having at least an access point that specifies said progressive file, said access point specifying at least one or more parts of said progressive file corresponding to at least one version of said object, and means for transmitting said electronic document to the destination entity, and means for transmitting the whole progressive file or part thereof,
said destination entity including means for receiving and interpreting said electronic document, and means for transmitting a request to said source entity, said request specifying one or more parts of said progressive file, obtained from reading said access point for the purpose of transferring said part or parts of the progressive file from said source entity to said destination entity.
